(19) United States
(12) Patent Application Publication
(10) Pub. No.: US 2007/0270397 A1
(43) Pub. Date: Nov. 22, 2007

(54) Method for Indexing Crystalline Solid Forms

(76) Inventors: Simon Bates, West Lafayette, IN (US); Igor Ivanisevic, West Lafayette, IN (US); Barbara C. Stahly, West Lafayette, IN (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/577,239

(22) PCT Filed: Oct. 27, 2004
(86) PCT No.: PCT/US04/35444

§ 371 Date: Feb. 27, 2007

Related U.S. Application Data
(60) Provisional application No. 60/514,523, filed on Oct. 27, 2003.
(60) Provisional application No. 60/546,976, filed on Feb. 24, 2004.

(51) Int. Cl. A01N 43/00

(52) U.S. Cl. 514/210.01; 514/241; 702/19; 514/649

(57) ABSTRACT

Crystalline solid forms may be characterized by their unit cell parameters through a process known as indexing. An embodiment of the invention searches for the unit cell parameters of a crystalline solid form using a Monte-Carlo algorithm that incorporates certain rules to reduce search space. Another embodiment refines the results of the search to identify the correct unit cell parameters of the crystalline solid form. These methods may be automated, conveniently requiring little interaction from the user. The indexing method of the invention may be applied, for example, to distinguish between different crystalline solid forms of a substance.

### CROSS REFERENCE TO RELATED APPLICATIONS

This application claims the benefit of priority to U.S. Provisional Application No. 60/514,523, filed on Oct. 27, 2003, the contents of which are incorporated by reference herein, and to U.S. Provisional Application No. 60/546,976, filed on Feb. 24, 2004, the contents of which are also incorporated by reference herein.

### SUMMARY OF THE INVENTION

This invention relates to the characterization of crystalline solid forms. The invention includes a method for determining the unit cell parameters of a crystalline solid form in a process known as indexing. An embodiment of the invention searches for the unit cell parameters of a crystalline solid form using a Monte-Carlo algorithm that incorporates certain rules to reduce search space. Another embodiment refines the results of the search to identify the correct unit cell parameters of the solid form. These methods may be automated, conveniently requiring little interaction from the user. The indexing method of the invention may be applied, for example, to distinguish between different crystalline solid forms of a substance.

### BRIEF DESCRIPTION OF THE DRAWING

The accompanying drawings illustrate several embodiments of the invention and, together with the description, serve to explain certain principles of the invention.

FIG. 1 illustrates a flowchart of an example processing environment consistent with the invention.

FIG. 2 illustrates a functional block diagram of an example computer system performing a variety of processes consistent with the invention.

FIG. 3 illustrates a flowchart of an exemplary searching method of the invention using a Monte-Carlo algorithm.

FIG. 4A illustrates a flowchart of an example first method for refining the results of the searching method of the invention, using a comparison of calculated and measured XRPD patterns.

FIG. 4B illustrates a flowchart of an example second method for refining the results of the searching method of the invention, which determines the space group and parameter positions within the unit cell of a search result.

FIG. 5A illustrates an example third method for refining the results of the searching method of the invention, through the calculation of an electron density map of the unit cell.

FIG. 5B illustrates an example fourth method for refining the results of the searching method of the invention, by calculating an XRPD pattern from an electron density map of the unit cell and comparing the calculated pattern with a control pattern.

FIG. 6 illustrates a flowchart of an exemplary application consistent with the present invention of distinguishing between, or matching, crystalline solid forms.

### DETAILED DESCRIPTION OF THE INVENTION

This invention relates to the characterization of crystalline solid forms. The invention includes a method for determining the unit cell parameters of a crystalline solid form in a process known as indexing. The indexing method of the invention may be applied, for example, to distinguish between different crystalline solid forms of a substance. This method may be used, for example, in a screen for identifying new crystalline solid forms of a substance.

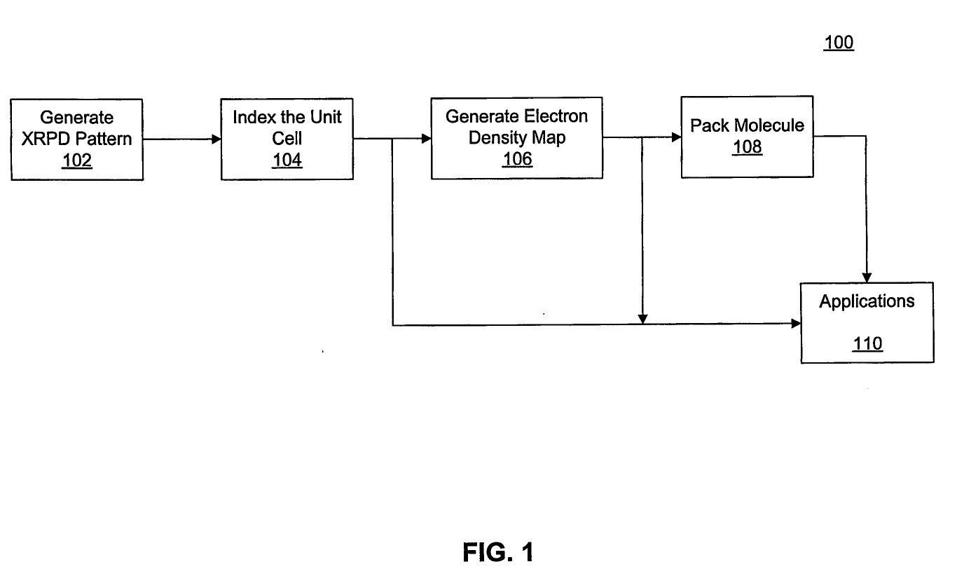

FIG. 1 illustrates a flowchart of an exemplary processing environment incorporating embodiments of the present invention for characterizing, distinguishing, and/or screening crystalline solid compounds. As shown in FIG. 1, characterizing, distinguishing, and/or screening environment 100 includes generating an X-ray powder diffraction (XRPD) pattern 102 of a crystalline solid form, indexing 104, generating an electron density map of the unit cell 106, determining the molecular packing 108, and applications 110.

XRPD is one of the most direct measurements of the crystalline solid form of a substance. The term “crystalline” as used herein includes polycrystalline, microcrystalline, nanocrystalline, or partially or wholly crystalline substances, as well as disordered crystalline substances. Crystalline solid forms can include, for example, cocrystals, solvates and hydrates. Crystalline solid forms can also include polymorphs, which are different crystalline solid forms having the same chemical structure. Crystalline solid forms can include crystalline forms of salts of compounds, for instance, salts of pharmaceutical compounds. Different solid forms will likely exhibit different XRPD patterns, so analysis of compounds, for example pharmaceutical compounds, often starts with generating and comparing XRPD patterns of the substance or substances under analysis.

Crystalline solid forms may be generated in numerous ways. For example, a plurality of crystalline samples of a substance can be generated in capillary tubes or in wells of a well-plate. The samples may be crystallized in different environments by, for instance, using different solvents, different temperatures, different humidities, or different pressures. These different conditions increase the likelihood of obtaining more than one crystalline solid form of a compound.

An X-ray powder diffractometer may be provided to generate the XRPD patterns of crystalline solid forms. Examples of such diffractometers include the Siemens D-500 X-ray Powder Diffractometer-Kristalloflex and a Shimadzu XRD-6000 X-ray powder diffractometer, using Cu-Ka radiation.

A computer system may index the unit cell 104 to determine crystal unit cell parameters of the substance under analysis. A crystal unit cell consists of 6 lattice parameters a, b, c, α, β, γ, which define a three dimensional framework of any crystalline lattice. Lattice parameters a, b, and c are lengths, while α, β, γ are angles.

The computer system may also generate an electron density map of the unit cell 106 and/or determine the molecular packing 108. Further, the computer system may execute software programs of applications 110 to complete characterizing, distinguishing, and/or screening solid compounds based on the results from indexing 104, from generating the electron density map of the unit cell 106, and/or from determining the molecular packing 108.

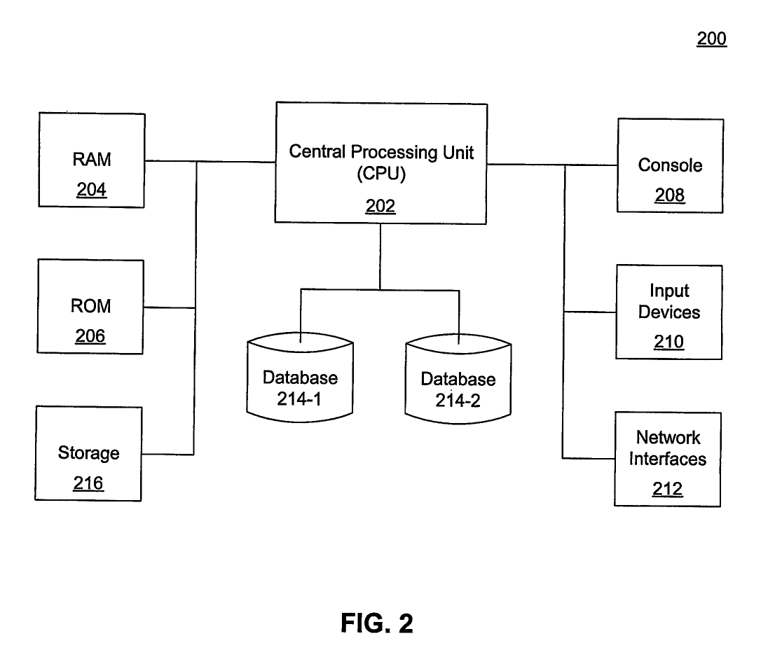

FIG. 2 shows a functional block diagram of an exemplary computer system performing processes consistent with the present invention. As shown in FIG. 2, computer system 200 may include a central processing unit (CPU) 202, a random access memory (RAM) 204, a read-only memory (ROM) 206, a storage 216, a console 208, input devices 210, network interfaces 212, and databases 214-1 and 214-2. The type and number of listed devices are exemplary only and not intended to be limiting, and the number of listed devices may be varied and other devices may be added without departing from the principle and scope of the invention.

CPU 202 may execute sequences of computer program instructions, more specifically, sequences of computer program instructions that cause CPU 202 to perform various processes as explained above. The computer program instructions may be loaded into RAM 204 for execution by CPU 202 from a read-only memory (ROM). Storage 216 may be any mass storage provided to store any type of information CUP 202 may need to perform operations. For example, storage 216 may be one or more hard disk devices, optical disk devices, or other storage devices to provide storage space for computer system 200.

Console 208 may provide a graphic user interface (GUI) to display information to users of computer system 200. Console 208 may be any type of computer display device or computer monitor. Input devices 210 may be provided for the users to input information into computer system 200. Input devices 210 may include a keyboard, a mouse, or other optical or wireless computer input devices. Further, network interfaces 212 may provide communication connections such that computer system 200 may be accessed remotely through computer networks.

Databases 214-1 and 214-2 may contain data and any information related to chemical compounds, such as chemical formulas, chemical properties of the compounds, structural properties of the compounds, packing properties of the compounds, XRPD patterns and calculation results. Databases 214-1 and 214-2 may also include analyzing tools for analyzing the information in the databases. CPU 202 may use databases 214-1 and 214-2 to characterize, distinguish, or screen different crystalline solid compounds. CPU 202 may also use databases 214-1 and 214-2 to predict certain properties of the compound consistent with the present invention.

As explained above, computer system 200 may first perform an indexing process 104 to identify potential unit cell parameters of crystalline solid forms of compounds. As a result, an embodiment of the invention includes a method for determining the crystal unit cell parameters of a crystalline solid form. The indexing process can be automatically performed by computer system 200.

Indexing process 104 may be divided into two sub-processes: a searching process and one or more refinement processes. One embodiment of the invention is a method for determining the crystal unit cell parameters of a crystalline solid form, which comprises

generating an X-ray powder diffraction pattern of a solid crystalline substance; and

determining the unit cell parameters of the substance by
generating a range of crystal unit cell parameters,
calculating the X-ray powder diffraction peak positions associated with the generated crystal unit cell parameters,
fitting the calculated X-ray powder diffraction peak positions to the actual X-ray powder diffraction peak positions of the substance, and

selecting the unit cell parameters that generate the X-ray powder diffraction peak positions of the substance.

For example, an embodiment of the invention includes a computer-implemented method of searching for the unit cell parameters of a crystalline solid form of a compound, which comprises:

performing a Monte-Carlo algorithm to identify one or more sets of values of unit cell parameters that produce calculated X-ray powder diffraction peak positions within a predetermined variance of the peak positions measured from an actual pattern of the crystalline solid form;

where the Monte-Carlo algorithm generates potential unit cell solutions beginning with a specified symmetry and with a specified volume within the confines of an estimated volume of the compound, and iteratively reduces the symmetry and/or increases the volume of the potential unit cell solution until identifying the one or more sets of values of unit cell parameters.

In the above embodiment, as well as all other embodiments of the invention, reference to a crystalline solid form of “a compound” includes a crystalline solid form comprising a compound and optionally one or more additional compounds or components, i.e., a multi-component system. For instance, a crystalline solid form of a compound includes a cocrystal and includes a salt of a compound. References to the estimated volume, molecular dimensions, stacking, packing ability and any other properties of the compound may therefore be adjusted as needed to allow for an analysis of multi-component systems.

In one example of the embodiment discussed above, the Monte-Carlo algorithm generates potential unit cell solutions beginning with the highest possible symmetry. In another example, the Monte-Carlo algorithm generates potential unit cell solutions beginning with the Orthorhombic symmetry. In another example, the Monte-Carlo algorithm generates potential unit cell solutions beginning with the lowest volume. In yet another example, the Monte-Carlo algorithm generates potential unit cell solutions beginning with the highest symmetry and lowest volume potential solution.

The Monte-Carlo algorithm may, for instance, generate potential unit cell solutions characterized by at least their symmetry and multiplicity, and may increase the volume of the potential unit cell solution by increasing the multiplicity of the potential unit cell solution. The algorithm may also generate potential unit cell solutions characterized by at least their symmetry and the number of molecules per asymmetric unit cell, and may increase the volume of the potential unit cell solution by increasing the number of molecules per asymmetric unit cell of the potential unit cell solution. As another example, the algorithm may generate potential unit cell solutions characterized by at least their symmetry and multiplicity and the number of molecules per asymmetric unit cell, and may increase the volume of the potential unit cell solution by increasing both the multiplicity and number of molecules per asymmetric unit cell of the potential unit cell solution.

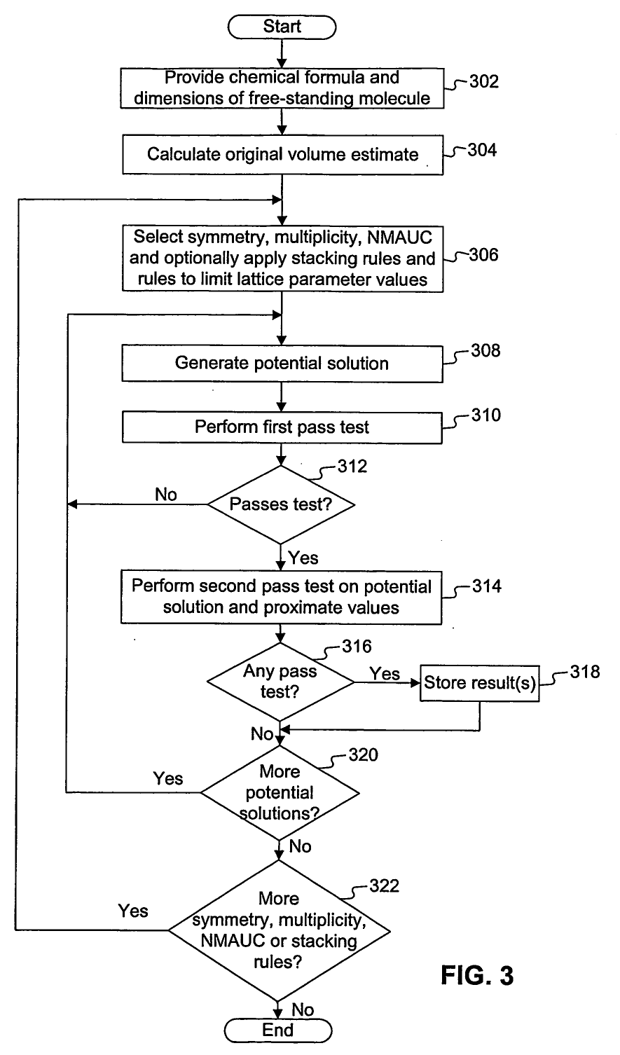

FIG. 3 illustrates one example of the searching embodiment of the invention. The Figure shows an exemplary flowchart of a searching process that can be performed by computer system 200, more specifically by CPU 202 of computer system 200.

As shown in FIG. 3, at the beginning of the searching process, CPU 202 may obtain a chemical formula and dimensions of the compound being indexed from either a user via input devices 210 or other data files on storage 216 (step 302). CPU 202 may then optionally use the formula and/or molecular dimensions to generate estimates of a molecular volume (step 304). To estimate the molecular volume, CPU 202 may use volume estimates for each individual atom in the formula, multiply each estimated volume by the number of those atoms present in the formula, and sum the multiplied estimates for a total estimate of the volume. For example, an HCl molecule has 1 hydrogen atom (H) and 1 chlorine atom (Cl). Hydrogen has a volume estimate of 5.08 Å³ and Cl has a volume estimate of 25.80 Å³. Thus, the HCl molecule would have a total volume estimate of 1*5.08+1*25.8=30.88 Å³. A table of the volume estimates of atoms, in cubic Angstroms, appears in the table below:

| | | | | | | | |
|---|---|---|---|---|---|---|---|
| H | 5.08 | Fe | 30.4 | Sb | 48 | Os | 41.9 |
| He | 10.0 | Co | 29.4 | Te | 46.7 | Ir | 34.3 |
| Li | 22.6 | Ni | 26 | I | 46.2 | Pt | 38 |
| Be | 36 | Cu | 26.9 | Xe | 45 | Au | 43 |
| B | 13.24 | Zn | 39 | Cs | 46 | Hg | 38 |
| C | 13.87 | Ga | 37.8 | Ba | 66 | Tl | 54 |
| N | 11.8 | Ge | 41.6 | La | 58 | Pb | 52 |
| O | 11.39 | As | 36.4 | Ce | 54 | Bi | 60 |
| F | 11.17 | Se | 30.3 | Pr | 57 | Po | 50 |
| Ne | 20 | Br | 32.7 | Nd | 50 | At | 55 |
| Na | 26 | Kr | 40 | Pm | 55 | Rn | 60 |
| Mg | 36 | Rb | 42 | Sm | 50 | Fr | 70 |
| Al | 39.6 | Sr | 47 | Eu | 53 | Ra | 60 |
| Si | 37.3 | Y | 44 | Gd | 56 | Ac | 74 |
| P | 29.5 | Zr | 27 | Tb | 45 | Th | 56 |
| S | 25.2 | Nb | 37 | Dy | 50 | Pa | 60 |
| Cl | 25.8 | Mo | 38 | Ho | 42 | U | 58 |
| Ar | 30 | Tc | 38 | Er | 54 | Np | 45 |
| K | 36 | Ru | 37.3 | Tm | 49 | Pu | 70 |
| Ca | 45 | Rh | 31.2 | Yb | 59 | Am | 17 |
| Sc | 42 | Pd | 35 | Lu | 35 | Cm | 70 |
| Ti | 27.3 | Ag | 35 | Hf | 40 | Bk | 70 |
| V | 24 | Cd | 51 | Ta | 43 | Cf | 70 |
| Cr | 28.1 | In | 55 | W | 38.8 | Es | 70 |
| Mn | 31.9 | Sn | 52.8 | Re | 42.7 | Fm | 70 |

In one embodiment, the user may specify a symmetry to be searched. Alternatively, CPU 202 can be programmed to automatically search one or more symmetries (step 306). For example, CPU 202 may set up the Monte-Carlo procedure to repeatedly search three common symmetries for many pharmaceuticals, such as Orthorhombic, Monoclinic and Triclinic. Optionally and/or alternatively, CPU 202 may also include other less common symmetries for many pharmaceuticals, such as Tetragonal, Rhombohedral, Hexagonal and Cubic, for automatic searching. However, CPU 202 may still allow a user to manually select symmetries to search.

Aside from the defined symmetries, at least two additional parameters, along with the original volume estimate, can determine the volume range to be searched. Those parameters are the multiplicity of the unit cell and the number of molecules per asymmetric unit cell (NMAUC). CPU 202 may select a multiplicity and/or a number of molecules per asymmetric unit cell (NMAUC) in step 306. Each symmetry has two different valid multiplicities. For example, valid Orthorhombic multiplicities may be 4 or 8, Monoclinic multiplicities may be 2 or 4, and Triclinic multiplicities may be 1 or 2. The multiplicity is applied as a multiplier to the original volume estimate for a particular symmetry. For example, when searching an Orthorhombic symmetry with a multiplicity of 4 (i.e., Orhtorhombic-4) with a volume estimate 30.88 (i.e., HCl), the actual base volume estimate would be 30.88*4=123.52. As another example, if a molecule is determined to occupy a volume of 522 Å³ then for a single molecule in the asymmetric unit, the volume expected for a triclinic structure with space group P-1 is 1044 Å³.

The NMAUC may also be applied as a straight multiplier to the volume estimate for a particular symmetry and may range from 1-6 for all symmetries. Thus, in the above example, when searching an Orthorhombic symmetry with a multiplicity of 4 (i.e., Orthorhombic-4) with an NMAUC of 2, the total base volume estimate would be 30.88*4*2=247.04. The actual volume range searched may be adjusted to some degree, for example by ±20% (i.e., 197.632 to 296.448).

With knowledge of the structure of a single molecule, it is possible to derive limits for the unit cell length parameters depending on the number of molecules in the asymmetric unit and the space group multiplicity. In this regard, and in addition to symmetry-multiplicity-NMAUC characteristics of a potential unit cell solution, the solution can be further characterized by the shortest and longest lattice parameters defined by formulas I and II:
Ds−2<Cs<Ds+5 (I)
Ch>Dh−3 (II)

where

Ds is the shortest molecular dimension,

Cs is the shortest lattice parameter,

Dh is the longest molecular dimension,

Ch is the longest lattice parameter, and

Ds, Cs, Dh and Ch are in Å, with these equations being the Gavezzotti rules described in detail in Gavezzotti, “Are crystal structures predictable,” Acc. Chem. Res. 27:309-314, 1994, the contents of which are incorporated by reference herein.

The Gavezzotti rules will estimate a range, or, multiple discontinuous ranges, of values of the unit cell parameters to reduce the search space in the Monte Carlo method. In the absence of the Gavezzotti rules, the user may define the limits of the lattice parameters used during the search. Those limits would typically be set to be very broad (for example 4 Å-40 Å for a, b, and c) in order to cover a wide variety of molecules. CPU 202 uses the Gavezzotti rules to reduce the search range of lattice parameters by applying information about the molecule's width, height, length.

The search space may furthermore be reduced by having knowledge of the stacking of the molecule of interest when the number of molecules per asymmetric unit cell is two or more. For example, the potential unit cell solution may be characterized, when having a number of molecules per asymmetric unit cell of two or more, by a side-by-side, head-to-toe or top-and-bottom stacking of any given molecules in the unit cell, following the Kitaigorodsky rules referenced in A. I. Kitaigorodsky, Organic Chemical Crystallography, Consultants Bureau: New York (1961), which is incorporated by reference herein.

In one embodiment, a variable frequency of occurrence for different stacking configurations may be introduced. The variable frequency of occurrence may indicate that some stacking configurations occur more frequently than others in, for example, pharmaceuticals, based on examinations of the molecules in a Cambridge database. For instance, long chains of molecules may be rare compared to more balanced (i.e., symmetrical) arrangements. Therefore, the Monte Carlo procedure may spend more time searching ones that occur more frequently in practice rather than spending the same amount of time searching all the lattice parameter ranges predicted by the Gavezzotti rules.

Estimated frequencies for each stacking configuration and the number of generated Monte-Carlo events for a given stacking adjusted by that frequency may be used by CPU 202 during the searching process. For example, a frequency of 5% may be assigned for a relatively rare stacking configuration of six molecules stacked in a long chain, compared to a higher frequency of 25% assigned to a more common stacking configuration of the same six molecules stacked three on top of three. One,embodiment of the invention is therefore the practice of the searching method, which comprises assigning a frequency to each possible stacking configuration of the molecules within any given symmetry/volume combination, and where the number of potential unit cell solutions generated for each possible stacking configuration is proportional to the assigned frequency of the stacking configuration.

Kitaigorodski's aufbau principle (KAP) may also be used to reduce search space in the Monte-Carlo search. See Perlstein, “Molecular Self-Assemblies. 5. Analysis of the Vector Properties of Hydrogen Bonding in Crystal Engineering,” J. Am. Chem. Soc. vol. 118, pp. 8433-8443 (1996), the contents of which are incorporated be reference herein. In practice, molecules are assembled into long range order using very few symmetry operators. The application of translation, screw, glide and inversion symmetry operators in various combinations on the molecule describe the significant majority of organic crystalline solid forms. In the application of the KAP method, an aggregate is formed along a single axis through the application of one or more of the symmetry operators (+translation). The molecular packing energy can then be minimized as a function of two molecular rotation angles and displacement along the translation axis. Specific hydrogen bonding rules can be applied to verify the lowest energy solutions and to provide estimates of the most likely unit cell parameters and symmetry operators. These most likely unit cells and symmetries are then used as limits in the Monte Carlo indexing method.

Knowledge of whether a molecular structure is chiral also allows the space group search to be limited to only the small subset of space groups that allow chirality. For instance, if a crystalline solid form of a chiral molecule starts to yield index solutions with unit cell volumes twice that of a single molecule, then the structure should either be Monoclinic P21 with 1 molecule per asymmetric unit or Triclinic P1 with 2 molecules per asymmetric unit.

The Monte-Carlo algorithm may begin generating potential solutions to the unit cell parameters (step 308) confined by the search space defined above. The Monte-Carlo procedure can be specifically designed such that the crystal unit cells are generated with equal probability over all regions of phase space.

An embodiment of this searching method comprises:

providing an estimated volume and, optionally, estimated molecular dimensions of the compound;

providing a potential unit cell solution characterized by at least its symmetry and multiplicity and the number of molecules per asymmetric unit cell;

generating one or more sets of values of unit cell parameters confined by the volume and, if applicable, molecular dimensions of the compound and by the provided potential unit cell solution;

calculating the X-ray powder diffraction peak positions associated with each of the generated sets;

calculating for each generated set the variance between the calculated peak positions and the peak positions measured from an actual X-ray powder diffraction pattern of the crystalline solid form;

identifying and storing any generated set of values of the unit cell parameters when the variance calculated for the set is below a predetermined value; and

rejecting any generated set of values of the unit cell parameters when the variance calculated for the set is above the predetermined value.

The search method may comprise, for example, one or more steps of reducing the symmetry of a potential unit cell solution while maintaining the volume of the potential solution; one or more steps of increasing the volume of a potential unit cell solution by increasing the multiplicity of the potential solution; one or more steps of increasing the volume of a potential unit cell solution by increasing the number of molecules per asymmetric unit cell of the potential solution; and/or one or more steps of changing the side-by-side, head-to-toe or top-and-bottom stacking of any given molecules in a potential unit cell solution, when the potential unit cell solution is characterized by a number of molecules per asymmetric unit cell of two or more.

The search method may comprise, for instance, a predetermined series of symmetries to search in the order of Orthorhombic (4), Monoclinic (2), Triclinic (1), Orthorhombic (8), Monoclinic (4) and Triclinic (2), with the numbers in parentheses being general multiplicities.

The algorithm can efficiently search for the highest symmetry and lowest volume solution. A volume/symmetry group includes all symmetries from the highest to the lowest. For each symmetry, the volume is adjusted according to the general multiplicity of that symmetry to give approximately the same number of diffraction peaks within the measurement range. For example, the lowest possible general multiplicity for Orthorhombic is 4 (O4), for Monoclinic is 2 (M2) and for Triclinic is 1 (T1). The smallest possible volume search would begin with O4 and step through M2 to end at T1. By beginning with O4 the search is weighted towards the highest symmetry possible for the smallest volume possible. The volume scales with the multiplicity so the volume of O4 is two times that of M2 and four times that of T1.

If no solutions are found within the first volume/symmetry group then the multiplicity can be increased to the next level. This increasing of the general multiplicity is equivalent to increasing the number of molecules in the asymmetric unit in its consequences on the volume limits. However, by moving up the multiplicity, new space groups symmetries may be applied. Increasing the number of molecules in the asymmetric unit does not change the applicable space groups. The second indexing pass may therefore be O8, M4, T2. If no solutions are found in the second pass, then the multiplicity can be increased further for Monoclinic and Orthorhombic. The highest general multiplicity for triclinic is 2 and, as a result, there are no Triclinic space groups for this 3rd pass. Although possible, increasing the multiplicity beyond the third level may in many cases not be needed as very few organic molecules pack in space groups with this high general multiplicity. So the third pass could be, for example, O16, M8.

To explore higher volumes the number of molecules in the asymmetric unit can be increased and the search begins again from the lowest multiplicity for each symmetry. The fourth pass could therefore again be O4, M2, T1, but now with 2 molecules in the asymmetric unit, but the volume limits for this search will be the same as the second pass (O8, M4, T2). It may therefore be most efficient to jump to O8, M4, T2 with 2 molecules and then match the space groups after the indexing search has completed.

Any predetermined number of potential solutions may be generated for any symmetry-multiplicity-NMAUC combination (step 306) alone or further characterized by the Kitaigorodsky or Gavezzotti rules. For each unit cell generated, peak positions of all possible diffraction peaks may be calculated from all possible crystalline ‘d’ (or q or theta) values for the generated unit cell. These calculated peak positions can then be compared to the measured peak positions and a match calculated according to the crystallographic factor R¹. The search may continue until a solution is found with an R¹ value below a pre-defined value, for instance <0.5 or <0.65 (steps 310 and 312).

Upon finding a solution with an R¹ value below the predefined value, the initial solution can be used as a seed in the Monte Carlo random generation and a number of unit cell solutions, for instance 200 or 500, can be explored in a random generation proximate to the seed unit cell (for example ±0.25 Å and ±1.0, degrees). The random generation around the seed can be continued until a unit cell is discovered with an R² value below a second defined value, for example 0.2 (steps 314 and 316). Unit cell solutions scoring below the R² value can be stored for later inspection and refinement (step 318). The Monte Carlo technique can then continue its search of phase space with equal density exploration until all of the allowed phase space is searched.

The peaks of the actual pattern and calculated pattern that are to be compared may be predetermined. For example, a generic list of peaks without symmetry rules may be used. Alternatively, the peaks to be compared may be a subset of all peaks that are specific to a given space group. An “actual pattern” of the crystal solid form as used herein includes a composite pattern of that crystalline solid form prepared using the pattern matching technique disclosed in U.S. Patent Application Publication No. US 2004/0103130 A1 to Ivanisevic et al. titled “System and Method for Matching Diffraction Patterns,” the contents of which are incorporated by reference herein.

The search process might not spend equal amounts of time in each symmetry-multiplicity-NMAUC combination because search spaces for various symmetries can be of different sizes. For example, a Triclinic symmetry has six independent variables (i.e., a, b, c, α, β, γ) while an Orthorhombic symmetry has only three variables (i.e., a, b, c), since three angles are fixed to 90°. Search space for Triclinic is therefore bigger than that for Orthorhombic, and the Monte-Carlo procedure may generate more events in the Triclinic space to have a higher chance of finding a correct solution. Also, the Monte-Carlo procedure may search more common combinations among pharmaceuticals (e.g. Monoclinic-2 with NMAUC of 1) than uncommon ones (e.g. Tricinic-2 with NMAUC of 6).

If a solution is found after the search (step 316; yes), CPU 202 may stores results of the solution in RAM 204 or storage 216 for further processing (step 318). CPU 202 may then determine whether additional potential solutions of the unit cell parameters are to be generated within that symmetry-multiplicity-NMAUC combination. If not, the search within that combination will end. If no solution is found after the search of a given symmetry-multiplicity-NMAUC combination (step 316, no), the algorithm may returns to step 306 to continue the searching process, changing one or more of the symmetry-multiplicity-NMAUC characteristics of the potential unit cell solution and repeating a search for sets of unit cell parameters that satisfy the R¹ and R² criteria until one or more solutions are found.

The search method of the invention may, for example, be programmed to generate a fixed number of potential unit cell solutions in total or within any given symmetry/volume combinations. Alternatively, the Monte-Carlo search may be programmed to continue, not confined by any maximum number of events, as along as some error metric between the calculated patterns and the measured pattern of the solid form is above a predetermined value. The error metric may be, for example, a sum-squared error between the patterns or may be crystallographic factor R¹ or R² mentioned above.

At any point, if a solution or if a group of solutions is found, the Monte-Carlo search may terminate, for example, at the conclusion of a given symmetry-multiplicity-NMAUC combination and may proceed to result refinement. Alternatively, the algorithm may perform one or more refinement steps of the invention immediately upon finding even one potential solution. In that instance, once the refinement for that solution is complete, the Monte-Carlo search may, for example, terminate or resume, depending on the quality of the solution from the one or more refinement steps.

Since results from the searching process may reach a large number, for example hundreds or thousands, one or more refinement methods may be performed automatically to reduce the number of the results to a smaller number. For example, the number of results may be reduced to five in certain embodiments and ultimately to one. As a result, a further embodiment of the invention is a first refinement method, which comprises:

providing stored results obtained from searching process of the invention;

calculating the X-ray powder diffraction pattern of each stored search result;

comparing each calculated pattern to an actual X-ray powder diffraction pattern of the crystalline solid form; and

ranking the results by the similarity of their calculated patterns to the actual pattern of the crystalline solid form.

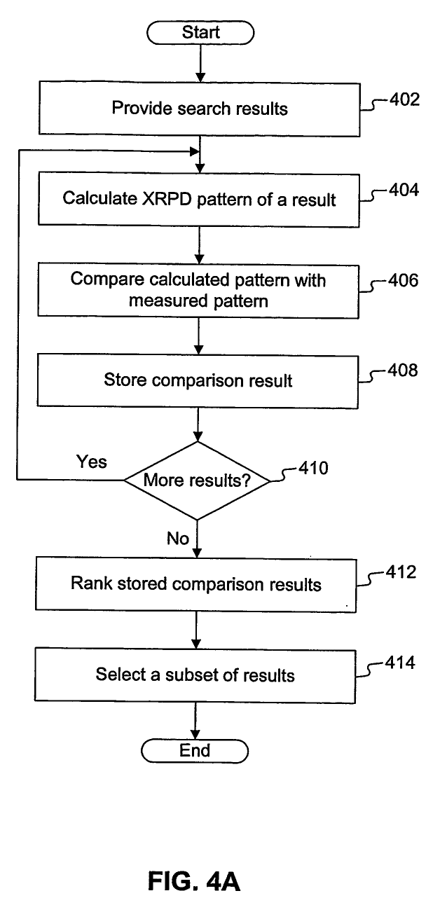

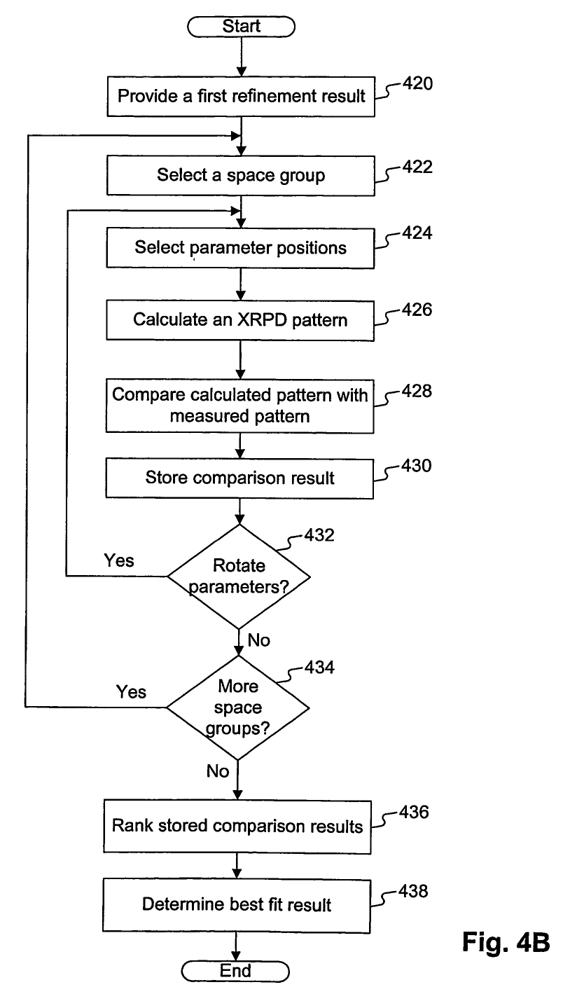

FIG. 4A shows an exemplary first refinement method of the invention. As shown in FIG. 4A, at the beginning of the refinement process, CPU 202 obtains searching results of the searching process (step 402). CPU 202 then uses cell parameters in each result to calculate an XRPD pattern (step 404) using the Le Bail refinement method. Further, CPU 202 compares the calculated pattern with the original measured XRPD pattern (step 406). The comparison may be performed based on predetermined criteria. For example, CPU 202 may compute a sum-squared error between the two patterns. Once the comparison is done, CPU 202 can store the result of the comparison either in RAM 204 or storage 216 (step 408).

Further, CPU 202 may determine whether all the searching results have been compared (step 410). If there are more searching results (step 410; yes), the refinement process returns to step 404. After processing all searching results (step 410; no), CPU 202 may then rank all results based on predetermined criteria (step 412). For example, results may be ranked according to smallest sum-squared error, and/or the number of peaks in the calculated pattern generated (i.e., fewest peaks). Afterwards, CPU 202 may select a subset of results from highest rankings as the results of the refinement process and the indexing process overall (step 414).

An embodiment of the first refinement method of the invention comprises choosing a subset of five non-duplicative results that generate the fewest peaks while maintaining close to the smallest error possible. Unselected searching results may be discarded, or optionally may be presented to the user.

A further embodiment of the invention is a second refinement method, which comprises:

providing the results obtained from the first refinement method; and

determining the space group and parameter positions for each unit cell that produce a calculated X-ray powder diffraction pattern having the closest fit to the actual pattern of the crystalline solid form.

An example of the second refinement method is shown in FIG. 4B. The space group and parameter positions for each unit cell may be determined by a method which comprises:

providing a predetermined number of potential space group solutions and potential positionings of the unit cell parameters (steps 422 and 424);

calculating the X-ray powder diffraction pattern associated with each of the generated space group solutions and positionings of the unit cell parameters (step 426); and

selecting the space group solution and positioning of the unit cell parameters that produces a calculated X-ray powder diffraction pattern that is the closest fit with the actual pattern of the crystalline solid form (steps 430438).

In an example of the second refinement method, the space groups and parameter positions are calculated in Le Bail fashion, by applying rules for each space group (different symmetries and multiplicities have different space groups available) and generating calculated patterns that are then compared to the measured pattern. The space group that best describes the measured pattern, with the caveat that all measured peaks must be described by the space group in question, is selected as the space group for that result.

Within the second refinement method, a further Monte-Carlo calculation may be performed to search proximate values of the unit cell parameters of any given solution in an effort to produce a pattern that more closely fits the measured pattern with any given space group and positioning of parameters. The parameter values resulting from the second refinement method may therefore be adjusted compared to the parameters used at the beginning of the refinement process.

The results of the second refinement method may be used to generate electron density maps of the unit cell of the refinement results. The unit cell can be used to determine reduced structure factors through the Le Bail fitting of the measured powder pattern. These structure factors can be converted into an electron density image through reverse Monte Carlo methods. A further embodiment of the invention is therefore a third refinement method, which comprises:

providing results obtained from the second refinement method;

calculating the electron density map of the unit cell associated with each of the results;

accepting any result that produces a valid electron density map of the unit cell; and

rejecting any result that does not produce a valid electron density map of the unit cell.

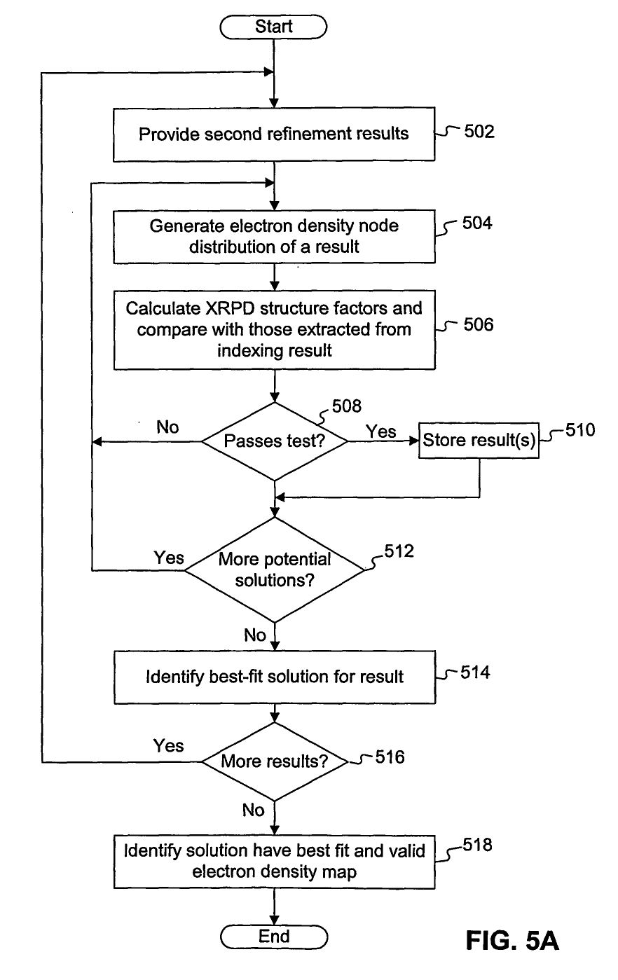

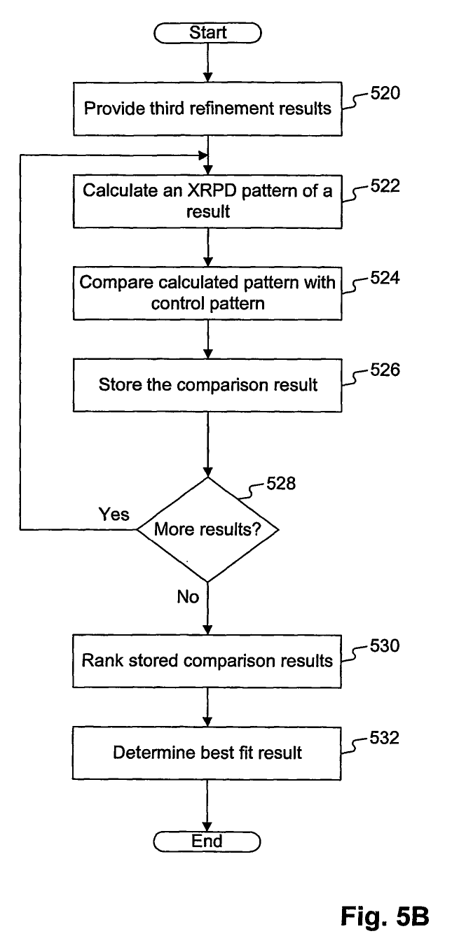

An embodiment of the third refinement method is shown in FIG. 5A. The electron density map of each result may be calculated by:

generating a predetermined number of potential electron density node distributions (step 504);

calculating the X-ray powder diffraction structure factors associated with each of the generated electron density node distributions (step 506);

selecting the electron density node distribution that produces calculated X-ray powder diffraction structure factors that are the closest fit with X-ray powder diffraction structure factors extracted from the unit cell corresponding to that result (steps 514-518).

As shown in FIG. 5, CPU 202 may start the process by obtaining the results representing crystal unit cells of crystalline solid forms from an indexing process as explained above (step 502). CPU 202 may then generate electron density node distributions within each of the crystal unit cells (step 504). Further, CPU 202 may calculate X-ray powder diffraction structure factors associated with the generated electron density node distributions (step 506). For those comparisons meeting a predetermined degree of similarity, the method may further search in certain neighboring ranges of the generated electron density distribution for a better fit.

CPU 202 may then determine whether all results from the indexing process have been refined (step 512). If more results need to be processed (step 516; yes), the process returns to step 504 to continue processing. After all the results from the indexing process have been processed (step 516; no), CPU 202 ranks the stored comparison results based on predetermined criteria and may further select an electron density node distribution with highest rank as the result of the electron density map generating process (step 516).

The electron density map of the unit cell can verify that an indexing solution is correct. The user may then view the electron density maps found for the solutions and reject solutions that are invalid. Each electron density image can be checked for validity by using a number of selection rules. For example, there should not be any large gaps in the electron density greater than 3 Å. There should be no multiple overlapping of high-density nodes. Electron density should not be gathered around symmetry points within the unit cell. Clear independent molecules should be visible in the electron density image. The unit cells corresponding to electron density images that satisfy the selection rules are good candidates for correct unit cell solutions. If more than one unit cell solution is selected by this automated procedure, then the different cells can be reduced to identify if they are related symmetries.

If the third refinement method of the invention produces more than one valid result, a fourth refinement method may be implemented. The fourth refinement method of the invention comprises:

providing accepted results obtained from the third refinement method;

calculating the X-ray powder diffraction pattern associated with each result;

comparing the calculated X-ray powder diffraction patterns with a control pattern; and

selecting the result that produces a calculated X-ray powder diffraction pattern that is the closest fit with the control pattern.

The control pattern may represent the actual pattern of the crystalline solid form of interest or may be a pattern calculated from the initial indexing result.

The refinement methods of the invention may be used independently of the specific searching method of the invention. For example, the refinement methods of the invention may be used to refine the results from any program used to search for the unit cell parameters of a crystalline solid form.

In view of all of the above, further embodiments of the invention also include a system for searching for the unit cell parameters of a crystalline solid form of a compound, which comprises a central processing unit programmed to execute the searching method of the invention and/or one or more refinement methods of the invention and a memory to store program code executed by the central processing unit. A further embodiment comprises a computer-readable medium for use on a computer system, the computer-readable medium having computer-executable instructions for performing the searching method and/or refinement methods discussed above. An additional embodiment of the invention comprises a crystalline solid form, where the crystalline solid form has been indexed by the methods of the invention.

After determining the electron density map of the unit cell of the substance under analysis, CPU 202 may also execute certain software programs to perform molecular packing of the substance. This may be performed using DASH (Cambridge Crystallographic Data Center). An embodiment of the invention is therefore a method for determining the molecular packing of a crystalline solid form, which comprises

generating molecular arrangements of the molecules of the substance;

calculating the electron density distribution associated with the generated molecular arrangements;

fitting the calculated electron density distributions to an electron density distribution extracted from the X-ray powder diffraction pattern of the substance; and

selecting the molecular packing that generates the electron density distribution extracted from the X-ray powder diffraction pattern.

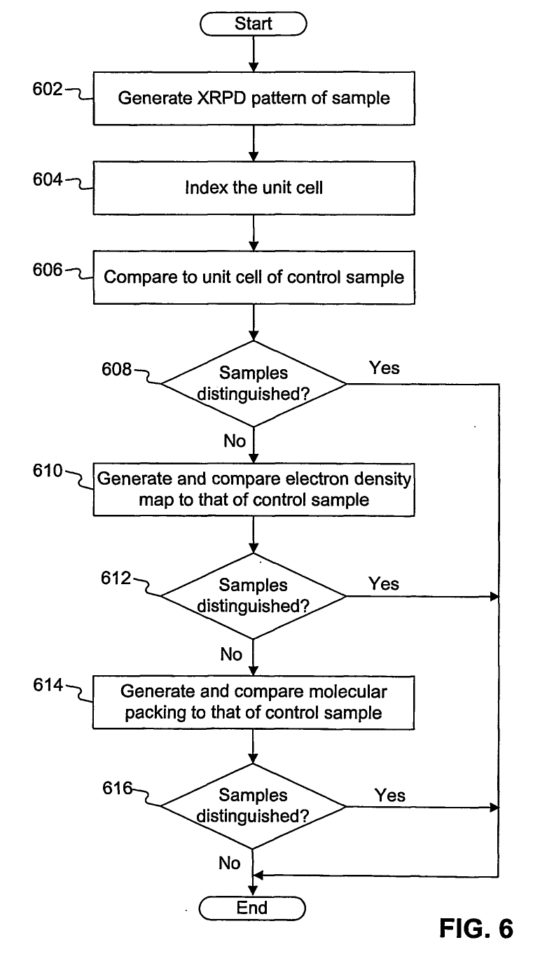

As explained above, index results, the electron density map of the unit cell and/or the molecular packing can be used separately or in combination by application software programs to distinguish or screen crystalline solid forms such as pharmaceuticals. For instance, an embodiment of the invention comprises comparing structural information obtained for different crystalline solid samples, such as the indexed unit cell, electron density map of the unit cell or molecular packing, to determine whether X-ray powder diffraction patterns of those samples represent the same or different crystalline solid forms. FIG. 6 illustrates an example of this embodiment.

This embodiment can comprise comparing structural information obtained for different crystalline solid samples, such as the results obtained from the searching method of the invention, the results of any one or more refinement methods of the invention, the indexed crystal unit cell, electron density map of the unit cell or molecular packing, to determine whether X-ray powder diffraction patterns of those samples represent the same or different crystalline solid forms. The calculation of the same crystal unit cell parameters, electron density map of the unit cell or molecular packing for samples represented by different X-ray powder diffraction patterns can indicate that the samples have the same crystalline solid form. Conversely, the calculation of different crystal unit cell parameters or a different electron density map of the unit cell or molecular packing for samples represented by different X-ray powder diffraction patterns can indicate that the samples do not have the same crystalline solid form.

An indexed unit cell can be used to determine relationships between the different crystalline solid forms of a single molecule. For example, it can assist in determining whether the crystalline solid forms are iso-structural and perhaps part of a single hydrate family. Indexing can be used to rule out false forms arising from poor particle statistics or preferred orientation. If an indexed crystal unit cell describes all measured diffraction peaks in a powder pattern, then most likely the sample material has the same crystal unit cell.

The ability to index a measured powder pattern may also rule out the possibility that the sample material is a mixture of different crystalline solid forms. The inverse can also be true. If a powder pattern cannot be indexed, then most likely the sample material is a mixture of different crystalline solid forms, ruling out another source of false form identification.

As shown in FIG. 6, a user of the application software programs may first generate XRPD patterns for all the samples of the substance under analysis, and input these patterns into computer system 200 (step 602). The user may then instruct computer system 200, more specifically CPU 202, to perform an indexing process (step 604). After the indexing process, CPU 202 determines possible crystal unit cells of the samples (step 606). CPU 202 may then determine whether all samples are distinguished based on the crystal unit cells (step 608). If not (step 608; no), CPU 202 may further calculate electron density maps of the samples (step 610), and determine whether all samples are distinguished based on the electron density maps (step 612). If the samples are still undistinguished (step 612; no), CPU 202 may further generate molecular packing of the sample to distinguish or match them (step 614).

A further embodiment of the invention comprises predicting one or more properties of a crystalline solid form in view of structural information specific to the form, such as the indexed crystal unit cell, electron density map of the unit cell or molecular packing. “Properties” of the crystalline solid forms include, but are not limited to, true density, stability (for example thermodynamic stability), solubility, compressibility, crystal shape, mechanical strength, morphology, and gross physical features such as channels and holes. Structural information specific to the form could include the indexed crystal unit cell, electron density map of the unit cell or molecular packing as determined by the methods of the invention described above.

Crystallographic information for different crystalline solid forms of a substance, including the indexed crystal unit cell, electron density map of the unit cell or molecular packing, can assist in predicting properties of the crystalline solid forms. Those predictions may, in turn, assist in selecting the crystalline solid form most desirable for a particular application.

Physical properties of a material, such as its true density, can often be estimated from the indexed unit cell. For many organic materials, material density correlates with the thermodynamic stability of the material. Indexing the individual crystalline forms can allow for a ranking of the forms according to true density and predicted thermodynamic stability. The most thermodynamically stable form of a substance, in turn, is often selected for manufacture.

The electron density map of the unit cell and molecular packing can also be used to predict physical properties of a crystalline material. Those physical properties could include density, compressibility, crystal shape, and mechanical strength. The molecular packing provides information as to how the molecules are packed into the crystal unit cell. The presence of channels or tunnels as well as interlocking chains in the molecular packing can be identified and related to the mechanical strength, stability and compressibility expected from the material. Those properties can relate, in turn, to the manufacturing properties of the material.

The presence of channels or tunnels may be related to material behavior under different humidity conditions, as water molecules may freely move through channels of specific sizes. Channels within the crystal structure can allow gases and solvents to pass freely throughout the crystal. As the crystal takes up or releases different amounts on “non-lattice” solvent, the crystal structure may relax and expand, giving a family of iso-structural forms. Such a material is often avoided for manufacturing due to the difficulties in controlling the final crystalline form and therefore chemical activity. Crystal structures exhibiting channels are typically easily compressible in directions normal to the channel direction.

The grouping of the electron density nodes may allow for the identification of specific atomic components within the crystal structure. This can be used to predict chemical activity of crystalline surfaces and therefore customize solvent solutions that can be used to engineer crystalline habit during production.

The electron density distribution and indexed unit cell can also be loaded into a Rietveld modeling program in place of the real crystal structure. This can allow for quantitative analysis of mixtures and the modeling of properties such as disorder and preferred orientation using other powder patterns measured as part of a screen.

The molecular packing may also indicate the type of chemical species that are present at each surface of a crystalline substance. This information could be used, for example, to design specific solvent solutions for growing preferred crystalline habits, or shapes, for manufacture. Knowledge of the actual molecule packing is therefore often an accurate predictor of physical material properties and chemical activity of different crystalline solid forms. Placing the actual molecule into the electron density map of the unit cell can allow for the identification of which atoms within which molecular environments are exposed at each crystalline surface. From this the chemical activity of each crystalline surface may often be predicted. Such information can be used to select the most appropriate solvent mixtures for growing crystal forms with the most appropriate shape for manufacture.

Another embodiment of the invention comprises comparing one or more predicted properties of different crystalline solid samples to determine whether X-ray powder diffraction patterns of those samples represent the same or different crystalline solid forms. Predictions of the same properties for samples represented by different X-ray powder diffraction patterns can indicate that the materials have the same crystalline solid form. Conversely, predictions of different properties for samples represented by different X-ray powder diffraction patters can indicate that the materials do not have the same crystalline solid form.

An additional embodiment of the invention comprises sorting or screening various crystalline solid forms on the basis of certain structural information specific to the forms, such as the indexed unit cell, electron density map of the unit cell or molecular packing. For instance, the invention comprises a method of screening for new crystalline solid forms of a substance, which comprises determining structural information for a plurality of crystalline samples of a substance using the embodiments described above, comparing the structural information of the samples to structural information of known crystalline solid forms of the substances, and identifying those crystalline samples that have structural information different from that of the known crystalline solid forms.

A further embodiment of the invention comprises sorting or screening various crystalline solid forms on the basis of predicted properties specific to the forms. For instance, the invention includes a method of screening for new crystalline solid forms of a substance, which comprises predicting one or more properties of a plurality of crystalline samples of a substance using the embodiments described above, comparing the predicted material properties of the samples to properties of known crystalline solid forms of the substances, and identifying those crystalline samples that have predicted properties different from those of the known crystalline solid forms.

### EXAMPLE 1

Rather than depend on the user's knowledge of the molecular volume of the crystalline solid form being indexed, this method simply requires as input the chemical formula of the form in question. The method uses the chemical formula to calculate an estimate of the unit cell volume by looking up the volume for each different atom, multiplying it by the number of those atoms present in the formula and then adding them all up. For example, H₂O contains two hydrogen atoms (each with a volume of 5.08) and one oxygen atom (volume 11.39) giving it a total volume estimate of 2×5.08+11.39=21.55. The final minimum and maximum volume bounds used in indexing might use the estimated number plus or minus a certain percentage, for instance 10-20%.

The general space group symmetry may or may not be specified. In the latter case, the method can automatically search all symmetries. Additionally, all relevant multiplicities can be searched for each symmetry. The aim of indexing in this embodiment is to derive the crystal unit that best describes the measured X-ray peak positions using the smallest unit cell volume and highest general symmetry.

By searching specific space groups in a specific order it is possible to ensure that the first set of solutions found will correspond to the highest symmetry and lowest volume. For example, the method may search the symmetries in the following order: Orthorhombic (4), Monoclinic (2), Triclinic (1), Orthorhombic (8), Monoclinic (4), Triclinic (2), Orthorhombic (16) etc through increasing multiplicity. The integer in parentheses after the general symmetry is the multiplicity of the molecule. Within each general symmetry are the specific space groups allowed by the molecule. For example, an organic chiral molecule will typically occupy Orthorhombic space groups P212121 and P21212 with a multiplicity of 4. The method may, at the option of the user or automatically, decide to stop after a solution is found or proceed looking for a better solution in other symmetries/multiplicities. Better solutions with higher volumes may later be reduced to the equivalent symmetry with smallest volume.

### EXAMPLE 2

In an embodiment of the invention, a Monte Carlo method is used to randomly generate crystal unit cells covering all unit cells (phase space) that are physically possible. The method is specifically designed such that the unit cells are generated with equal probability over all regions or phase space. This removes potential bias introduced by the Monte Carlo technique itself.

From the molecular size of the molecule of interest it is possible to estimate the range of values possible for a, b, c, α, β, γ and therefore the extent of phase space that requires searching. In many cases the extent of phase space that requires searching can be large. To reduce the search area, knowledge of the molecular volume can be used in conjunction with general space group symmetry to limit the possible unit cell volume within narrower values. The volume limit reduces the search area sufficiently such that search density required to uniquely identify the global solution can be achieved in less time. The application of space group symmetry to limit the search volume involves indexing each space group sequentially. The use of space group symmetry within the indexing process can allow for an accurate calculation of the material density once the unit cell has been indexed.

The Monte Carlo technique will randomly vary the unit cell parameters within the imposed volume restrictions and space group symmetry restrictions. For each unit cell generated, the peak positions of all possible diffraction peaks are calculated from all possible crystalline ‘d’ values for the unit cell. These calculated peak positions are then compared to the measured peak positions and a match calculated according to the crystallographic ‘R’ factor. The search continues until a solution is found with an ‘R’ value below some pre-defined value, for instance <0.5 or <0.65. At this point, the initial solution is used as a seed in the Monte Carlo random generation and a number of unit cell solutions, for instance 200 or 500, are explored in a random generation close to the seed unit cell (typically ±0.25 Å and ±1.0 degrees). The random generation around the seed is continued until a unit cell is discovered with an ‘R’ value below a second defined value, for example 0.2. Unit cell solutions scoring below the second ‘R’ value can be stored for later inspection. The Monte Carlo technique can then continue its search of phase space with equal density exploration until all of the allowed phase space is searched.

The calculation of the ‘R’ factor requires that the measured peak positions be accurately determined. The peak search technique disclosed in U.S. Patent Application Publication No. US 2004/0103130 A1, can be used to return peak positions along with the extent of each peak and a probability score related to the peak intensity. The probability score is used to rank the peaks and select only those peaks for which there is a 100% confidence that the peaks exist. The peak extent is used as an error window for scoring the match to the calculated peak positions from the unit cell. During the match process, if multiple calculated peaks lie within the error window of a measured peak, only the calculated peak closest to the measured peak is chosen for scoring. A triangular error function is used in the match scoring to discriminate against calculated peaks far from the measured peak position.

The indexing process concludes when all selected space group symmetries have been searched and returns a list of candidate unit cells whose ‘R’ factor is below the second limit. These unit cells can be interactively matched to the measured data set to reject solutions obviously incorrect by visual inspection. For each indexed unit cell solution a volume and density can be displayed to aid the operator in rejecting non physical unit cells. The remaining unit cell solutions can then be matched according to symmetry transformations to identify those cells that are related through symmetry operations. This typically reduces the number of candidate unit cells to a very small number.

The remaining unit cells can then be optionally refined using a Brent-Powell refinement process constrained by Le Bail conditions. In this refinement, the unit cell parameters along with known instrumental parameters are used to calculate a simulated powder pattern. This simulated powder pattern is refined with respect to the measured powder pattern using the Brent-Powell method with the unit cell parameters and instrumental parameters as variables. According to the Le Bail technique, the intensities of each peak are directly evaluated using individual scale factors at each iteration of the Brent-Powell method. Overlapped peaks are taken to have the same scale factor. The refinement continues until the ‘best’ fit of the simulated powder pattern to the measured powder pattern is achieved. The instrumental parameters used are discussed in U.S. Patent Application Publication No. US 2004/0103130 A1. The ability of this refinement pass to fully describe the measured powder pattern is a good indication that the indexed unit cell solution is correct.

The selection of the correct unit cell solution for the measured powder pattern allows the indexing of each measured peak according to which family of crystalline lattice planes generate the peak. In addition, the Le Bail method returns a series of structure factors for each peak, which can be used in the subsequent calculation of the molecular packing.

### EXAMPLE 3

Indexing was carried out on a crystalline solid form using a reverse Monte Carlo approach where unit cells are randomly generated within constraints derived from allowed molecular packing motifs. The constraints can be determined automatically based on space group packing rules or manually derived using methods such as those described below. At each iteration, the indexing program increases the number of molecules per asymmetric unit until a statistically acceptable sampling of unit cells has been completed or until an optimal solution has been found. For each unit cell that satisfies the physical constraints, a powder pattern is calculated using the Le Bail method and its suitability is scored using a least sum of squares error estimation with respect to the measured XRPD pattern.

Constraints on the indexing search space were derived as follows. The solid state NMR spectrum of the crystalline solid form did not exhibit the crystallographic splitting which is evident in the spectrum of a known crystalline solid form of the compound, suggesting that the crystalline solid form under analysis contains only one crystallographically independent molecule (i.e., one molecule in the asymmetric unit cell). Based on the structures of two known crystalline solid forms of the compound, it seemed likely that the new crystalline solid form has at least one 2₁ screw symmetry operation along the long axis of the molecule and has molecular packing described by a chiral space group. These structural features, coupled with consideration of the most common space groups describing organic crystals, limit the possible space groups to describe the new crystalline solid form to monoclinic P2₁ or orthorhombic P2₁P2₁P2 or P2₁P2₁P2₁.

A P2₁ solution can be assumed to have a target volume range of 825 to 875 Å³, the upper limit defined by the fact that there would be two molecules in the unit cell. The lower limit is defined by the assumption that the new crystalline solid form is less stable than a known crystalline solid form of the compound and, thus, the volume of the new crystalline solid form will be greater than the volume of the known crystalline solid form; with only two molecules in the unit cell the lower limit is one half of 1651 Å³, or 825 Å³. Furthermore, because of the head-to-tail molecular packing, it is possible to give some bounds to the expected unit cell parameters. For the P2₁ solution, the single molecule is aligned along the monoclinic axis with the 2₁ screw giving two molecules head-to-tail in the unit cell. Using the predictive rule that the lattice parameter x in a specific real space direction can be approximated by: nL−3<x<nL+5, where L is the length of the molecule in the specific lattice direction and n is the number of molecules in the symmetric unit aligned along the same direction (Gavezzotti, “Are crystal structures predictable,” Acc. Chem. Res. 27:309-314, 1994) then 19 Å<b<27 Å. In the same way, the lattice parameters for a and c can be given realistic bounds of 4 Å<a, c<9 Å.

Each orthorhombic solution (P2₁P2₁P2 or P2₁P2₁P2₁) would have four molecules in the unit cell. Using the same reasoning described above, the target volume is 1650 to 1750 Å³ and the unit cell lengths are 4 Å<a<9 Å, 19 Å<b<27 Å, and 5 Å<c<14 Å.

XRPD data obtained under standard conditions on a Shimadzu XRD-6000 diffractometer were indexed. An initial indexing pass using all ten visible peaks below 20° 2θ combined with the eight free-standing peaks between 20 and 30° 2θ yielded no viable solutions, even with a relaxed 2θ error of 0.25°.

A secondary indexing pass looking for only orthorhombic solutions used all fifteen free-standing peaks below 30° 2θ with an allowed 2θ error of 0.21°. The best Le Bail fit to the measured XRPD pattern was achieved by a P2₁2₁2 unit cell with a=6.128 Å, b=11.953 Å, c=22.001 Å and a volume of 1612 Å³. The R factor for this fit was 0.15 with a normalized, weighted, chi-squared error of 5.2.

A final indexing pass looking for only monoclinic solutions using the same default peak list described above identified a P2₁ solution with a unit cell having a=6.268 Å, b=21.931 Å, c=6.435 Å, β=107.745°, and a volume of 843 Å³. The R factor for this fit was 0.17 with a normalized, weighted, chi-squared error of 5.3.

Close inspection of the calculated Le Bail patterns for the P2₁ and P2₁2₁2 solutions with respect to the measured XRPD pattern shows that two overlapped peaks at 16.8 and 18.6° 2θ are not described by either solution. These unmatched peaks, which were included in the initial indexing search that failed, correspond to peaks of a known crystalline solid form of the compound and thus can be associated with low-level contamination by the known crystalline solid form.

A test of any indexing solution is the ability to pack the molecule into the chosen unit cell and approximate the measured XRPD peak intensities. DASH (version 2.2 from the Cambridge Crystallographic Database Center) was used to pack a rigid molecule in the two successful indexing solutions. No specific allowance was made for hydrogen bond requirements during packing and the carbon atom closest to the center of mass of the molecule was used as a center of rotation. The termination criteria for each packing iteration was either 5×10⁵ steps or the profile error for the complete pattern was twice the profile error (˜25) of the Pawley refinement for the strongest free-standing peaks. The orthorhombic P2₁2₁2 unit cell could not be packed with a rigid molecule to give an XRPD pattern which matched the measured pattern for the crystalline solid form. The best fit to the data gave a profile error of over 20 times the Pawley profile error with the resulting molecular packing having interlocking molecules centered on high symmetry points.

The monoclinic P2₁ unit cell was successfully packed with the best fit giving a profile chi-squared error of 59.6 and an intensity chi-squared error of 46.2. The profile error is higher than the target of 50 because the sample was contaminated with low levels of a known crystalline solid form of the compound. An embodiment of the present invention therefore includes a method for detecting two different crystalline solid forms in a mixture, including where one may be present in small amounts as a contaminant of another. The final refined lattice parameters are a=6.270 Å, b=21.927 Å, c=6.435 Å, and β=107.74°, with a volume of 843 Å³. The resulting molecular packing satisfies the asymmetric hydrogen bond requirement with sheets of the molecules in the ac plane aligned head-to-tail along the monoclinic axis and the methyl groups rotated 180° from one molecule to the next due to the 2₁ screw. The resulting crystal structure was loaded into the Rietveld program MAUD for final refinement of the molecule. Even in the presence of the known crystalline solid form contamination, MAUD was able to refine the complete molecular structure of the compound without breaking the molecule. The best model gave an R value of 0.1906 for the monoclinic P2₁ solution having a=6.261 Å, b=21.920 Å, c=6.432 Å, and β=107.81°.

### EXAMPLE 4

The structure factors (corrected peak intensities) and peak indices returned by the Le Bail technique discussed in Example 2 can be used to calculate the molecular packing. This calculation can proceed in two steps.

The first step is the calculation of a general electron density map within the crystal unit cell. The unit cell parameters a, b, c, α, β, γ determine the measured peak positions, but it is the distribution of electron density within the unit cell that determines the measured peak intensity. The reverse Monte Carlo method is again used to randomly populate the crystal unit cell with electron density nodes until a close fit is achieved with the extracted structure factors. At this point the Brent-Powell method is used to refine the node locations within the unit cell to best describe the structure factors. The choice of the number of nodes affects the accuracy of the method. The smallest number of nodes that accurately describe the extracted structure factors is preferred. This will be related to the size of the molecule and the number of peaks being modeled. Once a good fit to the extracted structure factors has been achieved, the same electron density node distribution and indexed unit cell can be used to calculate a simulated powder pattern. The simulated powder pattern should be in very close agreement with the measured powder pattern if the electron density node distribution is correct.

This method of modeling the electron density within the indexed unit cell makes no use of the actual molecule being studied and is not bound by physical constraints of the molecule. Therefore, the modeling process can be performed quickly and within a screening process. The ability to generate an electron density distribution within the indexed unit cell, that is capable of describing the measured powder pattern, is confirmation that the indexed unit cell solution is correct.

The determination of molecular packing incorporates the actual molecule within the crystal unit cell, packing the molecule into the electron density map of the unit cell. Packing the molecule uses a similar reverse Monte Carlo method to randomly generate possible molecular arrangements based upon the known number of molecules present in the unit cell and the known degrees of freedom available to the molecule. The process continues until the calculated electron density distribution associated with the molecular packing agrees with the extracted electron density distribution from the powder pattern.

### EXAMPLE 5

Based upon the indexed crystalline unit cell, the Le Bail refinement allows the extraction of structure factors from the measured data. The extracted structure factors can then be used to directly determine the electron density distribution within the crystalline unit cell. For low molecular weight molecules, the electron density is typically of sufficient resolution to identify the molecular packing symmetry. For larger molecular weight systems, even though the electron density may not be of sufficient detail to identify the details of the molecular packing, it can be used to verify the correctness of the indexing solution.

The electron density images calculated from incorrect indexing solutions display unusual symmetries and violate closest packing rules. The electron density image for a correct indexing solution can reflect the space group and 3D symmetry of the molecular packing. As such, the electron density can reflect the behavior of relative physical properties of the crystalline material. Predictions of physical properties based upon the crystalline unit cell dimensions and space group can be made more realistic through the inclusion of the electron density variation.

An example is the calculation of morphology using the Donnay-Harker methodology where the growth rate of the each crystalline face is inversely related to the separation of the faces. The electron density normal to the crystal face can modify this growth rate—the higher the projected electron density the faster the surface growth rate.

### EXAMPLE 6

A polymorph screen is carried out by robotic generation of 1200 solid samples, each sample weighing approximately 100 micrograms. The solid samples are analyzed by X-ray powder diffraction in an automated fashion. The 1200 resulting patterns are sorted into 5 different clusters of similar patterns by a pattern matching computer program, for example that disclosed in U.S. Patent Application Publication No. US 2004/0103130 A1. Examination of the patterns in each cluster suggests that the patterns in each cluster likely represent the same crystalline solid form, but there are numerous small variations in peak position and intensity among the patterns in each cluster as well as significant noise which obscures some of the smaller peaks. The patterns of each cluster are averaged together to provide a composite pattern of each cluster. These composite patterns are used to calculate unit cell parameters for each cluster.

During the indexing process, the molecular size and the angular position of the first diffraction peaks are used to estimate the range of values possible for the unit cell parameters, a, b, c, α, β, γ. This limits the extent of phase space that requires searching. The initial free standing peaks at low angles should be included in the target peak set. If any of these peaks are absent or if spurious peaks are included in this initial low angle range, then the indexing process may fail to find the correct solution. To reduce the search area further, knowledge of the molecular volume is used in conjunction with general space group symmetry to limit the possible unit cell volume within physically realistic values. It is expected that the indexing process carried out this way is much more efficient than traditional approaches and that the use of composites instead of single patterns makes the indexing more robust. The unit cell dimensions of each cluster are then compared to each other and it is found that Clusters 1 and 2 have the same unit cell parameters and are likely representing the same crystalline solid form. Clusters 3, 4, and 5 are each unique and it is believed they represent different crystalline solid forms.

### EXAMPLE 7

In a polymorph screen similar to that in Example 6, Clusters 1 and 2 give similar but not identical unit cell parameters. It is not known whether they actually represent the same crystalline solid form. Electron density and molecular packing determinations are carried out for Clusters 1 and 2 using the techniques of the invention. It is determined that the materials have the same sheet-like molecular packing but differ slightly in the distance between sheets, and are actually the same crystalline solid form.

### EXAMPLE 8

It is desired to make a directly compressible form of drug substance Z. The commercial form of Z, Form A, is not compressible. A polymorph screen is carried out, and two new crystalline solid forms are found: Form B and Form C. Indexing and electron density distribution determination are carried out for Forms B and C. The presence of channels in Form B is clearly indicated. Form C appears to contain interlocking molecules. Crystal structures exhibiting channels are easily compressible in directions normal to the channel direction, while interlinking of molecules can make a material difficult to compress. Form B is selected for further study.

### EXAMPLE 9

A drug substance X crystallizes into very thin needles, similar to hairs. No other morphology is known and all attempts to gather single crystal data from the hairs have been unsuccessful because the hairs are too thin. A sample of drug substance X is gently crushed and powder X-ray diffraction data is collected. The powder pattern is used to generate unit cell parameters. The unit cell parameters coupled with peak intensity information from the original powder pattern are used to derive an electron density map of the unit cell. The electron density map is used to determine the molecular packing in the unit cell, using the techniques of the invention. The molecular packing information shows which functional groups are present on the faces of the crystal. This functionality information is used to design additives that will interact with the fast-growing end-of-the-needle face in solution and slow down the growth of that face thereby changing the morphology to a more sphere-like shape and enhancing the drug substance handling properties.

### EXAMPLE 10

A polymorph screen is carried out by manual generation of 600 solid samples, each sample weighing approximately 200 micrograms. The solid samples are analyzed by XRPD. The 520 usable patterns resulting from the analysis are sorted into 10 different clusters of similar patterns by a pattern matching computer program. It is desired to further evaluate each cluster to further refine the pattern matching result. The first pattern in each cluster is used to calculate unit cell parameters for each cluster. Clusters 1, 2, and 3 have the same unit cell parameters and actually represent the same crystalline solid form. Clusters 4, 6, and 8 are not able to be indexed, indicating that they are likely mixtures of crystalline solid forms. Clusters 5, 7, 9, and 10 each have unique unit cell parameters and are likely to be unique crystalline solid forms. The indexing data of unique Clusters 1, 5, 7, 9, and 10 are used to calculate true densities, which are used to predict stability order. It is predicted that Cluster 1 represents the most stable crystalline solid form followed by 9, 10, 5, then 7 as the least stable form. Indexing data are used to determine electron density distribution and molecular packing of all clusters. It is concluded that Clusters 2 and 3 are simply disordered crystalline versions of the crystalline solid form represented in Cluster 1.

It is understood that the processes disclosed above are exemplary only and not intended to be limiting. Existing steps may be removed, the order of the steps may be changed, and new steps may be added without departing from the principle and scope of the present invention.

We claim:

1. A computer-implemented method of searching for the unit cell parameters of a crystalline solid form of a compound, which comprises:
performing a Monte-Carlo algorithm to identify one or more sets of values of unit cell parameters that produce calculated X-ray powder diffraction peak positions within a predetermined variance of the peak positions measured from an actual pattern of the crystalline solid form;
where the Monte-Carlo algorithm generates potential unit cell solutions beginning with a specified symmetry and with a specified volume within the confines of an estimated volume of the compound, and iteratively reduces the symmetry and/or increases the volume of the potential unit cell solution until identifying the one or more sets of values of unit cell parameters.

2. A method as claimed in claim 1, where the Monte-Carlo algorithm generates potential unit cell solutions beginning with the highest possible symmetry.

3. A method as claimed in claim 1, where the Monte-Carlo algorithm generates potential unit cell solutions beginning with the Orthorhombic symmetry.

4. A method as claimed in claim 1, where the Monte-Carlo algorithm generates potential unit cell solutions beginning with the lowest possible volume.

5. A method as claimed in claim 1, where the Monte-Carlo algorithm generates potential unit cell solutions characterized by at least their symmetry and multiplicity, and which comprises increasing the volume of the potential unit cell solution by increasing the multiplicity of the potential unit cell solution.

6. A method as claimed in claim 1, where the Monte-Carlo algorithm generates potential unit cell solutions characterized by at least their symmetry and the number of molecules per asymmetric unit cell, and which comprises increasing the volume of the potential unit cell solution by increasing the number of molecules per asymmetric unit cell of the potential unit cell solution.

7. A method as claimed in claim 1, where the Monte-Carlo algorithm generates potential unit cell solutions characterized by at least their symmetry and multiplicity and the number of molecules per asymmetric unit cell.

8. A method as claimed in claim 7, which comprises increasing the volume of the potential unit cell solution by increasing the multiplicity and number of molecules per asymmetric unit cell of the potential unit cell solution.

9. A method as claimed in claim 1, where the Monte-Carlo algorithm generates potential unit cell solutions within the confines of estimated molecular dimensions of the compound.

10. A method as claimed in claim 9, where the limits on lattice parameters of the potential unit cell solutions are determined according to formulas I and II:
Ds−2<Cs<Ds+5 (I)
Ch>Dh−3 (II)
where
Ds is the shortest molecular dimension,
Cs is the shortest lattice parameter,
Dh is the longest molecular dimension,
Ch is the longest lattice parameter, and
Ds, Cs, Dh and Ch are in Å.

11. A method as claimed in claim 9, where the limits on lattice parameters of potential unit cell solutions are determined by molecular packing energy minimization for specific space group symmetry operators and hydrogen bond networks.

12. A method as claimed in claim 1, where, for potential unit cell solutions characterized by a number of molecules per asymmetric unit cell of two or more, the potential unit cell solutions are further characterized by a side-by-side, head-to-toe or top-and-bottom stacking of any given molecules in the unit cell.

13. A method as claimed in claim 12, which comprises assigning a frequency to each possible stacking configuration of the molecules, and where the number of potential unit cell solutions generated for each possible stacking configuration is proportional to the assigned frequency of the stacking configuration.

14. A method as claimed in claim 1, which comprises:
providing an estimated volume and, optionally, estimated molecular dimensions of the compound;
providing a potential unit cell solution characterized by at least its symmetry and multiplicity and the number of molecules per asymmetric unit cell;
generating one or more sets of values of unit cell parameters confined by the volume and, if applicable, molecular dimensions of the compound and by the provided potential unit cell solution;
calculating the X-ray powder diffraction peak positions associated with each of the generated sets;
calculating for each generated set the variance between the calculated peak positions and the peak positions measured from an actual X-ray powder diffraction pattern of the crystalline solid form;
identifying and storing any generated set of values of the unit cell parameters when the variance calculated for the set is below a predetermined value; and
rejecting any generated set of values of the unit cell parameters when the variance calculated for the set is above the predetermined value.

15. A method as claimed in claim 1, which comprises one or more steps of reducing the symmetry of a potential unit cell solution while maintaining the volume of the potential solution.

16. A method as claimed in claim 11, which comprises one or more steps of changing the side-by-side, head-to-toe or top-and-bottom stacking of any given molecules in a potential unit cell solution.

17. A method as claimed in claim 1, where the calculation of the variance between the calculated and measured X-ray powder diffraction peak positions comprises a first pass calculation of a crystallographic factor R¹.

18. A method as claimed in claim 17, which comprises rejecting any generated set of values of the unit cell parameters when the crystallographic factor R¹ calculated for that set is above a predetermined value of R¹.

19. A method as claimed in claim 1, where the calculation of the variance between the calculated and measured X-ray powder diffraction peak positions for one or more sets of values of the unit cell parameters comprises a first pass calculation of a crystallographic factor R¹ below a predetermined value of R¹, and which further comprises
generating a predetermined number of additional sets of values of unit cell parameters proximate to each of the initially-generated sets that produced the first pass calculation of R¹ below the predetermined value of R¹;
calculating the X-ray powder diffraction peak positions associated with each of the additional generated sets;
calculating for each additional generated set the variance between the calculated peak positions and the peak positions measured from the actual X-ray powder diffraction pattern of the crystalline solid form;
identifying and storing any initial or additional generated set of values of the unit cell parameters when the variance calculated for the set is below a predetermined value of a crystallographic factor R², where R²<R¹; and
rejecting any generated set of values of the unit cell parameters when the variance calculated for the set is above R².

20. A method as claimed in claim 19, which comprises generating the additional sets of values of the unit cell parameters within ±0.25 Å of the initially-generated unit cell lengths and within ±1 degree of the initially-generated unit cell angles.

21. A first refinement method, which comprises:
providing stored results obtained from the method of claim 1;
calculating the X-ray powder diffraction pattern of each stored search result;
comparing each calculated pattern to an actual X-ray powder diffraction pattern of the crystalline solid form; and
ranking the results by the similarity of their calculated patterns to the actual pattern of the crystalline solid form.

22. A method as claimed in claim 21, which comprises selecting and storing a predetermined number of non-duplicate results that produce calculated patterns having the fewest peaks and a sum-squared error with the actual pattern below a predetermined value.

23. A second refinement method, which comprises:
providing the results obtained from the method of claim 22; and
determining the space group and parameter positions for each unit cell that produce a calculated X-ray powder diffraction pattern having the closest fit to the actual pattern of the crystalline solid form.

24. A method as claimed in claim 23, which comprises determining the space group and parameter positions for each unit cell by a method which comprises:
providing a predetermined number of potential space group solutions and potential positionings of the unit cell parameters;
calculating the X-ray powder diffraction pattern associated with each of the generated space group solutions and positionings of the unit cell parameters; and
selecting the space group solution and positioning of the unit cell parameters that produces a calculated X-ray powder diffraction pattern that is the closest fit with the actual pattern of the crystalline solid form.

25. A method as claimed in claim 24, where the closest fit with the actual pattern of the crystalline solid form is the lowest sum-squared error between the calculated and actual patterns.

26. A third refinement method, which comprises:
providing results obtained from the method of claim 23;
calculating the electron density map of the unit cell associated with each of the results,
accepting any result that produces a valid electron density map of the unit cell; and
rejecting any result that does not produce a valid electron density map of the unit cell.

27. A method as claimed in claim 26, which comprises calculating the electron density map of the unit cell of each result by a method which comprises:
generating a predetermined number of potential electron density node distributions;
calculating the X-ray powder diffraction structure factors associated with each of the generated electron density node distributions;
selecting the electron density node distribution that produces calculated X-ray powder diffraction structure factors that are the closest fit with X-ray powder diffraction structure factors extracted from the unit cell corresponding to that result.

28. A fourth refinement method, which comprises:
providing accepted results obtained from the method of claim 26;
calculating the X-ray powder diffraction pattern associated with each result;
comparing the calculated X-ray powder diffraction patterns with a control pattern; and
selecting the result that produces a calculated X-ray powder diffraction pattern that is the closest fit with the control pattern.

29. A method for determining the unit cell parameters of a crystalline solid form of a compound, which comprises:
providing a plurality of sets of unit cell parameters, one of which describes the correct values of the unit cell parameters of the crystalline solid form or values of the unit cell parameters that are proximate to the correct values of the unit cell parameters of the crystalline solid form; and
performing a refinement method to identify the solution to the unit cell parameters of the crystalline solid form, which comprises:
calculating the X-ray powder diffraction pattern of each stored search result;
comparing each calculated pattern to an actual X-ray powder diffraction pattern of the crystalline solid form;
selecting and storing a predetermined number of non-duplicate results that produce calculated patterns having the fewest peaks and a sum-squared error with the actual pattern below a predetermined value;
determining the space group and parameter positions for the unit cell of each result;
calculating the electron density map of the unit cell associated with each of the results;
accepting any result that produces a valid electron density map of the unit cell; and
rejecting any result that does not produce a valid electron density map of the unit cell.

30. A system for searching for the unit cell parameters of a crystalline solid form of a compound, which comprises a central processing unit programmed to execute the method of claim 1 and a memory to store program code executed by the central processing unit.

31. A system for determining the unit cell parameters of a crystalline solid form of a compound, which comprises a central processing unit programmed to execute the method of claim 29 and a memory to store program code executed by the central processing unit.

32. A computer-readable medium for use on a computer system, the computer-readable medium having computer-executable instructions for performing the method of claim 1.

33. A computer-readable medium for use on a computer system, the computer-readable medium having computer-executable instructions for performing the method of claim 29.

34. A method for distinguishing between crystalline solid forms of different samples of a substance, which comprises:
for each sample, selecting and storing a predetermined number of non-duplicate results of possible solutions to the unit cell parameters obtained from the method of claim 22; and
comparing the predetermined number of non-duplicate results of one sample to those of another sample; and
evaluating the difference between the results to determine whether the different samples represent the same or different crystalline solid forms.

35. A method for distinguishing between crystalline solid forms of different samples of a substance, which comprises:
providing, for each sample, one or more valid electron density maps of the unit cell obtained from the method of claim 26; and
comparing the one or more valid electron density maps of one sample to one or more valid electron density maps of another sample; and
evaluating the difference between the electron density maps between the samples to determine whether the different samples represent the same or different crystalline solid forms.
